(19) United States
(12) Patent Application Publication
(10) Pub. No.: US 2022/0358613 A1
(43) Pub. Date: Nov. 10, 2022

(54) MODELING FLOOD RISK FOR A REGION

(71) Applicant: StormSensor Inc., Seattle, WA (US)

(72) Inventors: Erin Rothman, Seattle, WA (US); Emily Mistick, Seattle, WA (US); Suzie Housley, Seattle, WA (US)

(21) Appl. No.: 17/661,986

(22) Filed: May 4, 2022

Related U.S. Application Data
(60) Provisional application No. 63/185,794, filed on May 7, 2021.

(51) Int. Cl. G06Q 50/26; G06F 16/29

(52) U.S. Cl. CPC G06Q 50/265; G06F 16/29

(57) ABSTRACT

The invention includes a method that accesses map data for a region and for a set of flood risk factors. The map data is transformed to a common data schema. The transformed map data is subdivided into a set of sub-regions. For each sub-region, a set of flood risk factor scores is determined based on the transformed map data. The set of flood risk factor scores corresponds to the set of flood risk factors. For each sub-region, a composite flood risk score is determined. Determining the composite flood risk score for the sub-region is based on a combination of flood risk factor scores included in the set flood risk factor scores corresponding to the sub-region. A flood risk report is generated for the region. The flood risk report is based on the set of flood risk factor scores and the composite flood risk score corresponding to each of the sub-regions.

### CROSS-REFERENCE TO RELATED APPLICATIONS

This application is claims priority to U.S. Provisional Patent Application No.: 63/185,794, entitled MAPPING SPATIAL FLOOD RISK, filed May 7, 2021, the contents of which is hereby incorporated by reference in its entirety.

### BACKGROUND

Water management system operators have limited resources and highly heterogeneous consumers within their region. In order to prioritize resource allocation, operators need to evaluate flood risk of regions under their care. Governmental agencies, such as the Federal Emergency Management Agency (FEMA), provide flood risk maps suitable for this purpose. These maps may provide a basic flood risk model, which serves as the basis for regulations and flood insurance requirements. However, operators need more robust models to prioritize resource allocation among regions under their care.

### SUMMARY

Various aspects of the technology described herein are generally directed towards one or more of methods, system, and/or non-transitory computer readable storage media. Embodiments of the present invention are directed toward systems and methods for modeling absolute and relative flood risk among sub-regions within a region. The flood risk models generated in the various embodiments may be more robust than those provided by FEMA and FEMA-like maps. In some embodiments, such systems and methods are applied to historical stormwater data and system utilization data. In other embodiments, such systems and methods are applied to real- or near real-time stormwater and utilization data. In still other embodiments, a combination of both historical and real-time data is employed to generate one or more models. In various embodiments, such regions within an area can be defined in different ways—representing watershed basins, census tracts, zip codes, FEMA flood zones, or others.

In some embodiments, the model may be used to generate reports. In some embodiments, such reports can take the form of maps (e.g., heat maps). Such maps may illustrate an aggregate (or composite) risk index per sub-region or each risk factor per sub-region or both. More specifically, a report may include one or more heat maps for the models region. Each heat map may display a variance (across the modeled region of an absolute and/or a relative risk value for various risk factors, such as but not limited to elevation risk, flood zone risk, household income risk, population density risk, impervious surface area risk, and the like. Such risk factors may be referred to as flood risk factor types.

### BRIEF DESCRIPTION OF THE DRAWINGS

The technology described herein is described in detail below with reference to the attached drawing figures, wherein:

FIG. 1 includes a block diagram showing a flood risk quantification environment, in which some embodiments of the present disclosure may be employed;

FIG. 2 includes a block diagram showing a flood risk quantification platform that is consistent with the various embodiments;

FIG. 3A includes a map of a region that is subdivided into sub-regions via watershed basins and is consistent with the various embodiments;

FIG. 3B shows heat maps of the summary statistics for various flood risk factor types, according to various embodiments;

FIG. 3C shows additional heat maps of the summary statistics for additional flood risk factor types, according to various embodiments;

FIG. 4 shows heat maps for various composite and non-composite risk scores for the watershed basin-based subdivision schema that is consistent with various embodiments;

FIG. 5A shows heat maps for relative (composite) risk scores for the watershed basin-based subdivision schema that is consistent with various embodiments;

FIG. 5B provides a total (composite) risk table for the watershed basin-based subdivision schema that is consistent with various embodiments;

FIG. 6 provides a flow diagram that illustrates a method for modeling a flood risk for a region that is consistent with the various embodiments; and

FIG. 7 is a block diagram of an exemplary computing environment suitable for use in implementing aspects of the technology described herein.

### DETAILED DESCRIPTION

### Overview of Technical Problems, Technical Solutions, and Technological Improvements

The embodiments are directed towards a flood risk quantification (FRQ) platform. The FRQ platform employs a multi-data source model that determines absolute and relative risk scores for a region (and sub-regions of the region). The various risk scores may include absolute and/or relative risk metrics or risk indexes. The variance of the various flood risks scores over the sub-regions may be visualized in various heat maps of the region. The FRQ platform may generate a flood risk report for the region. The risk report includes the various absolute and relative risk scores, along with the corresponding heat maps.

The FRQ platform collects flood-risk data from multiple sources for the region, transforms the flood-risk data (e.g., the multiple sources may provide the flood-risk data in multiple formats and/or multiple data schemas) into a common data schema. In various embodiments, the various data sources may have subdivided the region into different sub-regions. Transforming the multiple flood-risk data may include mapping the different flood-risk data into a common subdivision of the region. That is, transforming the flood-risk data may include mapping each source of data into common sub-regions of the region. Once the multiple sources of flood-risk data is in a common data schema, the FRQ platform can summarize the flood risk data (e.g., calculate one or more summary statistics from the data). The FRQ platform can then normalize the various statistics over multiple regions to generate a set of risk indexes (or risk scores) per sub-region of the region. The FRQ platform may then combine the risk indexes, via the multi-data source risk model, to generate one or more composite risk scores. The FRQ platform may then generate various heat maps and a flood risk report, which includes the various information generated in the flood risk analysis. In various embodiments, the flood risk report may be an “interactive” report that is made available either as a downloadable interactive report (e.g., an application) or accessible online (e.g., the interactive report is provided as a dynamic web page).

More particularly, the FRQ platform employs physical parameters, such as but not limited to surface imperviousness and elevation. The FRQ platform additionally employs social data, such as but not limited to income, population density, and land use. A geographic region may be a city, county, or state. A region may be subdivided into sub-regions, or risk management zones (RMZs). A sub-region or RMZ may be a geographic sub-region of the region. The region may be subdivided into sub-regions (or RMZs) based on zip codes, census tracts, watershed basins, evenly spaced grids, individual property parcels, or any other such mechanism.

The FRQ platform calculates (via the multi-data source model) absolute and relative flood risk scores for sub-regions within a geographic region. Various risk factors contribute to one or more composite flood risk scores. For example, regions with a high share of impervious surface areas such as rock or pavement are at higher flood risk as they experience less water infiltration to ground and shed relatively more water into stormwater systems. For another example, elevation is negatively correlated with risk, as water tends to run off from higher elevation regions and accumulate in lower elevation regions.

A flood risk index may be calculated for a flood risk parameter for each region or sub-region in an area. In some embodiments, the index is calculated by calculating a summary statistic within each region (e.g., mean elevation, median household income, etc.) and normalizing the results over the area. Such an index per region can be reported or mapped for users. Two or more such flood risk indices can be combined to generate a composite flood risk index for each region. Such composite flood risk indices can similarly be reported or mapped.

Geospatial flood risk parameter data (e.g., flood risk data) can be received from public or private entities on open source or on proprietary bases. Such flood risk data may be formatted in various ways, using various map projections and being aggregated over different regions. For example, household income data may be aggregated within census tracts while Federal Emergency Management Agency (FEMA) flood risk (or map) data may be aggregated within FEMA-defined flood zones. Such geospatial data for various risk parameters can be re-projected and/or transformed to one or more region mappings or schemas.

The risk factor parameters can be combined in various ways to produce total risk indices suited for various purposes. Or, the system may project future risk posed by rising seawater levels by increasing weight given to an elevation parameter index. Model weighting can be determined through various statistical methods and machine learning techniques. Note that the embodiments are not limited to linear models, and other model types may be employed. For example, the model may be a polynomial model, an exponential model, a periodic series model, or any combination thereof.

Risk index data can be reported in various ways. Maps can be generated to display each index as a layer, selectable by users. Maps can further be optionally overlaid with information such as road maps or stormwater system maps.

### Environments and Systems for Modeling Flood Risk for Regions of the Globe

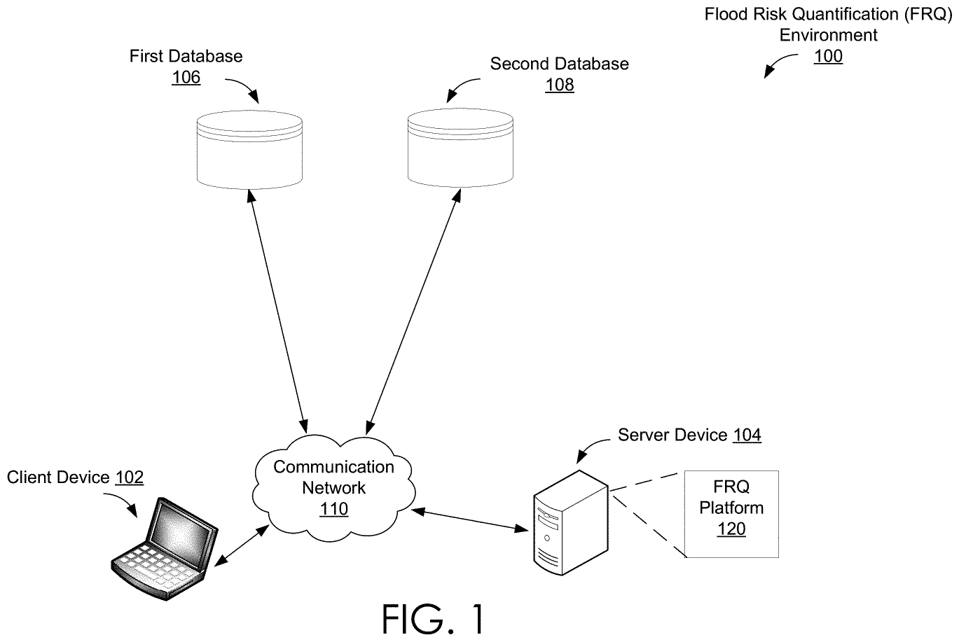

Aspects of the technical solution can be described by way of examples and with reference to FIG. 1 and additional illustrations below. FIG. 1 includes a block diagram showing a flood risk quantification (FRQ) environment 100, in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

FRQ environment 100 includes a client device 102, a server device, a first database 106, and a second database 108. Some embodiments may include additional databases that are not explicitly shown in FIG. 1. The client device 102, the server device 194, the first database 106, and the second database 108 are communicatively coupled through a communication network 110. At least one of the client device or the server device 104 may implement a FRQ platform 120.

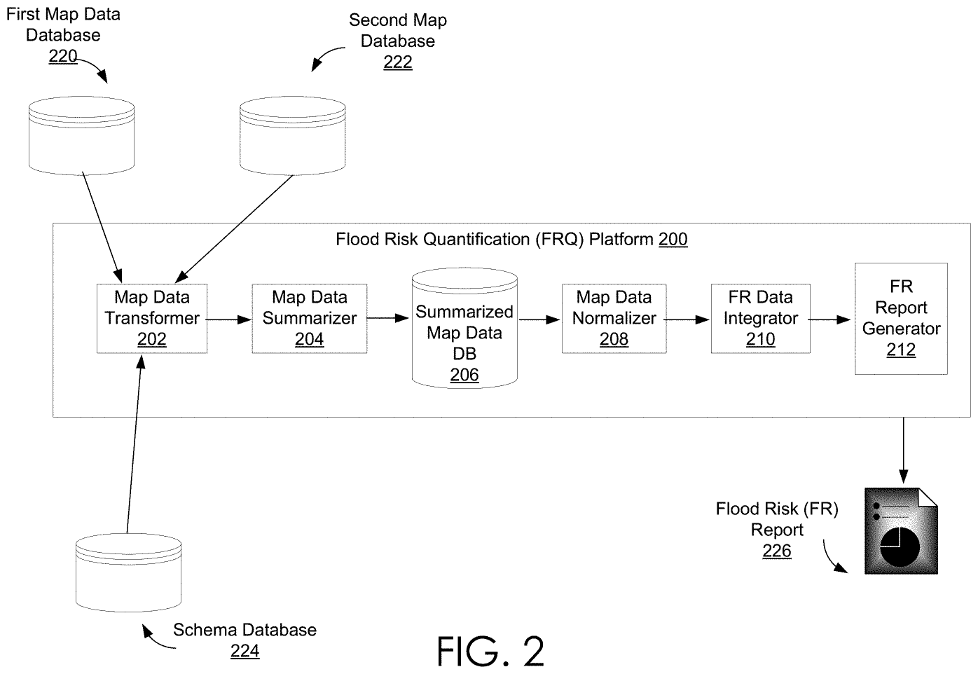

Various functionalities, operations, and/or features of the FRQ platform 120 are discussed in conjunction with at least FIG. 2. However, briefly here, the FRQ platform 120 employs a multi-data source model that determines absolute and relative risk scores for a region (and sub-regions of the region). For example, the FQR platform 120 may receive first flood-risk data from the first database 106 and receive second flood-risk data from the second database 108. The various risk scores may include absolute and/or relative risk metrics or risk indexes. The variance of the various flood risks scores over the sub-regions may be visualized in various heat maps of the region. The FRQ platform 120 may generate a flood risk report for the region. The risk report includes the various absolute and relative risk scores, along with the corresponding heat maps.

The FRQ platform 120 collects flood-risk data from multiple sources for the region (e.g., first database 106 and second database 108), transforms the flood-risk data (e.g., the multiple sources may provide the flood-risk data in multiple formats and/or multiple data schemas) into a common data schema. In various embodiments, the various data sources may have subdivided the region into different sub-regions. Transforming the multiple flood-risk data may include mapping the different flood-risk data into a common subdivision of the region. That is, transforming the flood-risk data may include mapping each source of data into common sub-regions of the region. Once the multiple sources of flood-risk data is in a common data schema, the FRQ platform 120 can summarize the flood risk data (e.g., calculate one or more summary statistics from the data). The FRQ platform can then normalize the various statistics over multiple regions to generate a set of risk indexes (or risk scores) per sub-region of the region. The FRQ platform 120 may then combine the risk indexes, via the multi-data source risk model, to generate one or more composite risk scores. The FRQ 120 platform may then generate various heat maps and a flood risk report, which includes the various information generated in the flood risk analysis. In various embodiments, the flood risk report may be an “interactive” report that is made available either as a downloadable interactive report (e.g., an application) or accessible online (e.g., the interactive report is provided as a dynamic web page).

Communication network 110 may be a general or specific communication network. Communication network 110 may be any communication network, including virtually any wired and/or wireless communication technologies, wired and/or wireless communication protocols, and the like. Communication network 110 may be virtually any communication network that communicatively couples a plurality of computing devices and storage devices in such a way as to computing devices to exchange information via communication network 110.

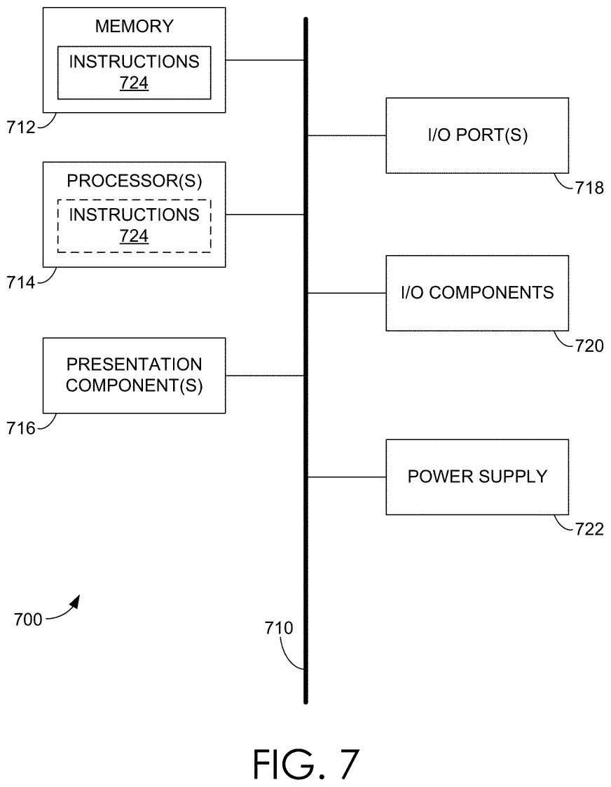

It should be understood that environment 100 shown in FIG. 1 is an example of one suitable operating environment. Each of the components shown in FIG. 1 may be implemented via any type of computing device, such as computing device 700 described in connection to FIG. 7, for example. These components may communicate with each other via network 110, which may include, without limitation, a local area network (LAN) and/or a wide area networks (WAN). In exemplary implementations, communications network 110 comprises the Internet and/or a cellular network, amongst any of a variety of possible public and/or private networks. Operating environment 100 can be utilized to implement any of the various embodiments described herein.

### Exemplary Embodiment of a Flood Risk Quantification (FRQ) Platform

FIG. 2 includes a block diagram showing a flood risk quantification (FRQ) platform 200 that is consistent with the various embodiments. FRQ platform 200 may be similar to FQR platform 120 of FIG. 1. FRQ platform 200 (as well as FRQ 160) may include various components and/or modules. In the non-limiting embodiment of FIG. 2, FRQ platform 200 may include at least a map data transformer 202, a map data summarizer 204, a summarized map data database 206, a map data normalizer 208, a FR data integrator 210, and a FR report generator 212. As noted above, the FRQ platform generates a static or dynamic flood risk report 226.

The map transformer 202 is generally responsible for accessing and/or receiving map data (e.g., map datasets) from multiple data sources (e.g., first map data database 220 and second map data database 222). First map data database 220 may be similar to first database 106 of FIG. 1 and second map data database 222 may be similar to second database 108 of FIG. 1. In various embodiments, the map data transformer 202 may receive additional map data from additional map data databases not shown in FIG. 1 or FIG. 2. Each map data database may provide map data (e.g., a map dataset) for a region for one or more risk domains and/or risk factors. For instance, first map data database 220 may provide a first map dataset that is or corresponds to the Federal Emergency Management Agency (FEMA) flood zone map data. The second map data database 220 may provide a second map dataset that is or corresponds to flood risk due to and/or associated with land cover (e.g., urbanization, deforestation, and/or cultivation). Thus, FEMA flood zones and land use are two flood risk domains or factors that are employed by FRQ platform 200. In addition to flood zones and land use FR factors, the FRQ platform may consider other flood risk factors, such as but not limited to land imperviousness, land elevation, income (of the population that resides on the land), population density, and the like.

A separate map data database may provide the map dataset for each FR factor that is considered relevant for the region. Thus, the map data transformer 202 may receive and/or access FEMA flood zone map data, land cover map data, imperviousness map data, elevation map data, income map data, and population density map data. Map data transformer 202 may receive and/or access other map data types and/or FR risk factors from additional and/or alternative map data databases.

Each of the separate map datasets (e.g., each corresponding to a separate FR factor or domain) may be received in a separate data schema and/or data format. In addition to receiving and/or accessing multiple sources of map data, the map data transformer 202 is generally responsible for transforming each of the map datasets from its native data schema to a common data schema. For instance, the FEMA flood zones map data (or dataset) may be received in a first data schema, while the land cover map dataset is received in a second data schema. That is, the native data schema of the FEMA flood zones map dataset may be the first data schema, while the native data schema of the land use map dataset may be the second data schema. The map data transformer 202 may transform the FEMA flood zones map dataset from the first data schema into a third data schema. Similarly, the map data transformer 202 may transform the land cover map dataset from the second data schema into the third data schema. The map data transformer 202 may transform each of the other received and/or access map datasets from its native data schema to the common third data schema.

Each of the native data schemas, as well as the common data schema may be stored in the schema database 224. In some embodiments, a schema map (or schema transformation operator) may be stored for each of the native data schemas. Such a schema map for a native data schema may provide a mapping from the native data schema to the common data schema. As noted above, a region may be subdivide into sub-regions or risk management zones (RMZs). A sub-region or RMZ may be a geographic sub-region of the region. The region may be subdivided into sub-regions (or RMZs) based on zip codes, census tracts, watershed basins, evenly spaced grids, individual property parcels, or any other such mechanism. In addition to having separate native data schemas, each map dataset may subdivide the region differently. For example, the FEMA flood zone map dataset may subdivided the region into non-overlapping sub-regions via evenly spaced grids, while the land use map dataset may subdivide the region by zip codes.

Another responsibility of the map data transformer 202 may be to transform the separate subdivisions of the region for each map dataset into a common subdivision of the region. The common subdivision of the region may be provided by a user and/or may be based on any possible subdivision schema (or subdivision mechanism), such as but not limited to watershed basins or census tracts. In such embodiments, the map data transformer 202 may transform the subdivisions of the FEMA flood zone map dataset from the grid-based subdivisions into the common subdivision schema (e.g., watershed basin-based subdivision schema or census tract-based subdivision schema). Likewise, the map data transformer 202 may transform the subdivisions of the land use map dataset from the zip code-based subdivisions into the common subdivision schema. The transformation of the disparate sub-regions of the various map datasets into a common subdivision schema may be performed by various multi-dimension data interpolation methods, such as but not limited to inverse distance weighting, splines, and the like. As noted above, a user may provide the common subdivision schema to the FRQ platform 200.

Once all the map datasets are converted to a common data schema and a common subdivision schema, the transformed map datasets may be provided to the map data summarizer 204. The map data summarizer 204 is generally responsible for generating one or more summary datasets for each map dataset. A summary dataset for a FR factor may include one or more summary statistics for the corresponding transformed map dataset. One or more summary statistics may be calculated for each sub-region of the common subdivision schema. Such summary statistics may include, but are not otherwise limited to mean (or median) elevation (for the sub-region), mean household income (for the sub-region), fraction of impervious surfaces (for the sub-region), mean population density (for the sub-region), mean land use (for the sub-region), or the like. The map data summarizer 204 may calculate such statistics based on the transformed map datasets and/or other data, such as but not limited to socioeconomic datasets, United States Geological Survey (USGS) datasets, US census generated datasets, or any public and/or private dataset.

The one or more statistics for each region, each sub-region, and/or for each FR risk factor may be stored as summarized map data in the summarized map data database 206. The map data normalizer 208 is enabled to access the summarized FR data stored in the summarized map data database 206. The map data normalizer 208 is generally responsible for normalizing each of the summary statistics across the common sub-regions. Once the summary statistics are normalized, the map data normalizer 208 may determine a risk score (or risk index) for each FR factor and for each of the common sub-regions based on the one or more summary statistics for each of the sub-regions. Because for each FR factor (e.g., FEMA flood zone, land cover, imperviousness, elevation, income, population density, and the like), a separate risk score is determined, the risk scores determined by the map data normalizer 208 may be referred to as FR factor risk scores (or FR factor risk indexes). In some embodiments, a FR factor risk score may be referred to as a FR factor risk score, or simply a FR factor score (or FR factor index). The map data normalizer 208 may generate a separate set of FR factor risk scores for each sub-region of the region. The set of FR factor risk scores for a sub-region may include a risk score for each of the relevant FR factors. The map data normalizer 208 may encode the various sets of FR factor risk scores in a 2D array data structure (or matrix or 2-tensor) of risk scores, where a first dimension (or a first index) of the 2D array corresponds to the FR factor factors and a second dimension (or a second index) of the 2D array corresponds to the sub-regions. The components of the 2D array or matrix store the various FR factor risk scores. The FR factor risk scores for the various FR factors stored in the 2D array may be referred to as non-composite risk scores (or non-composite risk indexes). The various sets of FR factor risk scores (and/or the 2D array that stores them) may be referred to as FR factor data.

The FR data integrator 210 is generally responsible for employing a model to generate one or more composite risk scores (or composite risk indexes) by combining the FR factor risk scores (e.g., stored in the 2D array) in various ways. The model may be a linear model that combines the various FR factor risk scores (or non-composite risk scores) associated with the various risk factors via weighted sums. In other embodiments, the model may be a non-linear model that combines the FR factor risk scores via one or more non-linear relationships. The FR data integrator 210 may integrate the various FR factor risk scores in various ways to generate the one or more composite risk scores. One or more composite risk scores may be calculated for each of the sub-regions in the region. For example, the FR data integrator 210 may generate an absolute (composite) risk score and a relative (composite) risk score for each sub-region. The FR data integrator 210 may combine (or integrate) the absolute and/or relative composite risk scores (via the model) to generate a total absolute and/or relative risk score for the entire region. For example, the FR data integrator 210 may determine a weighted linear sum (e.g., a mean or median) of the corresponding scores for the sub-regions. The various risk scores (composite and non-composite) may be passed to the FR report generator 212.

The FR report generator 212 is generally responsible for compiling the various (composite and non-composite) risk scores and generating the flood risk report 226. In various embodiments, the flood risk report 226 may be an “interactive” report that is made available either as a downloadable interactive report (e.g., an application) or accessible online (e.g., the interactive report is provided as a dynamic web page). In other embodiments, the flood risk report 226 may be a static report. The flood risk report 226 may include (static or interactive) heat maps for the composite and non-composite risk scores.

### Exemplary Embodiment of an Interactive Flood Risk Report

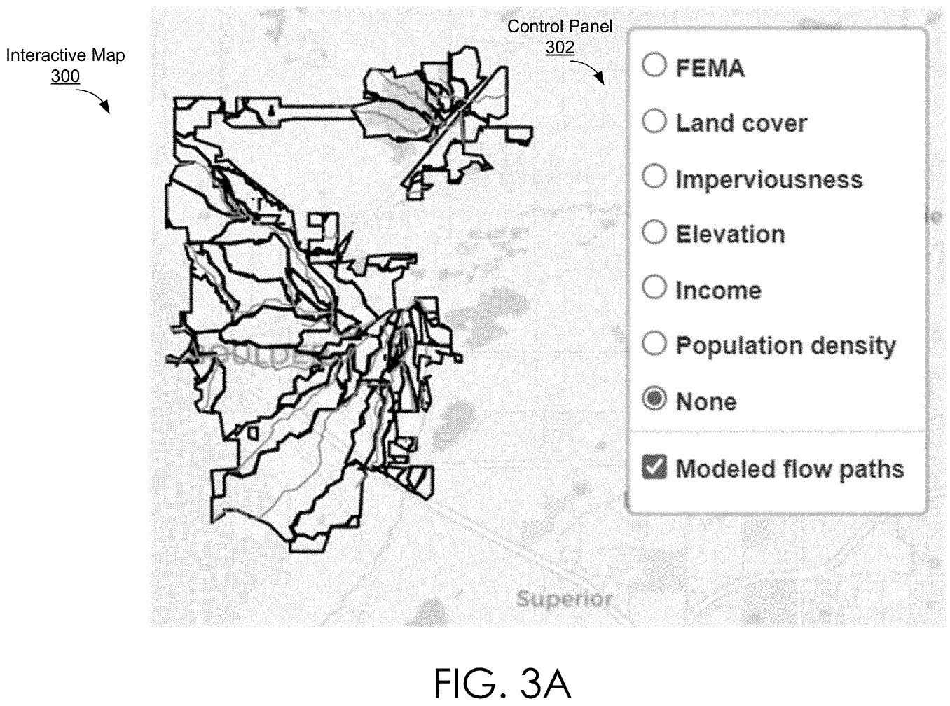

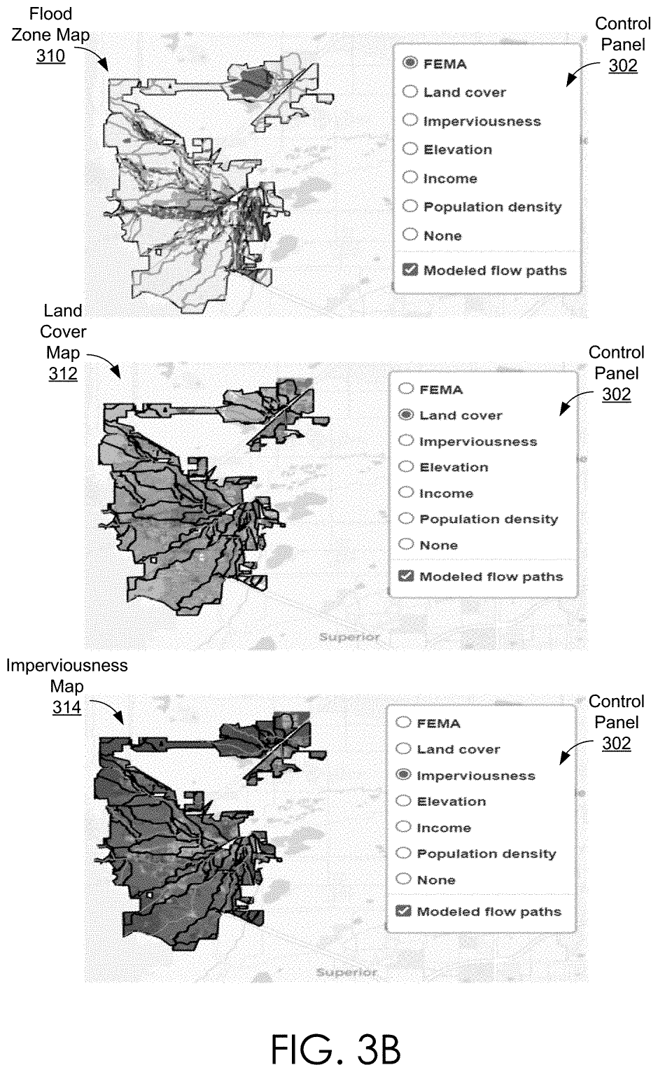

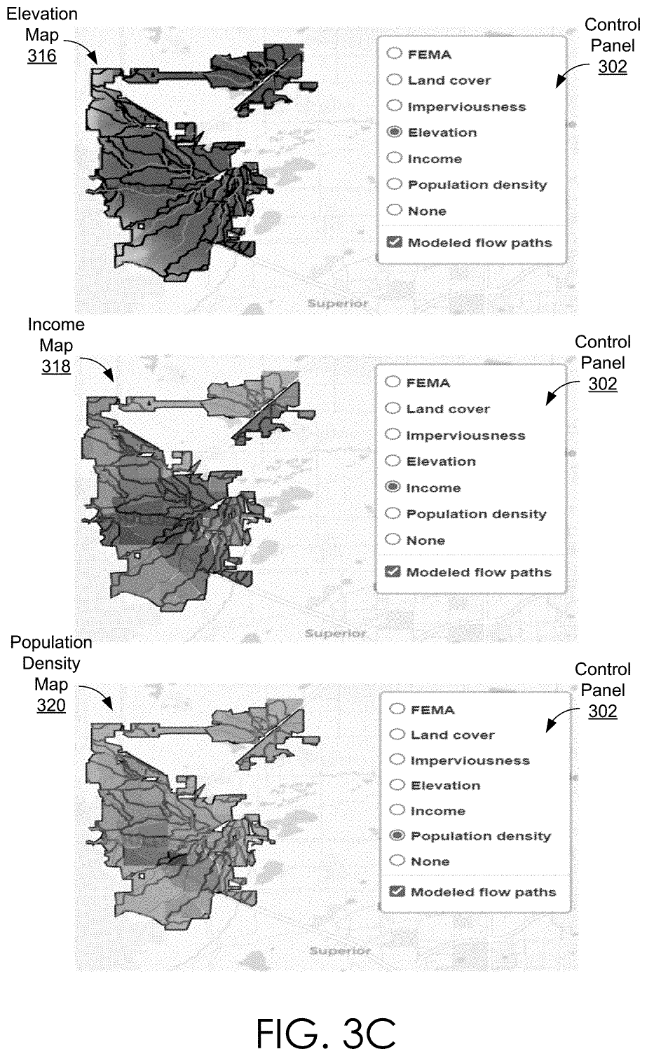

FIG. 3A includes a map 300 of a region that is subdivided into sub-regions via watershed basins and is consistent with the various embodiments. Map 300 may be included in a flood risk report (e.g., flood risk report 226 of FIG. 2). In the non-limiting embodiment of FIG. 3A, map 300 is a map of Boulder, Colorado. Thus, the flood risk report is a flood risk report for Boulder. Map 300 may be an interactive map and include and include a control panel 302. The control panel may have selectors (e.g., radio buttons) for each of the FR factors, considered in the flood risk analysis. In the non-limiting embodiment of FIG. 3A, the control panel 302 includes radio buttons for the FR factor types: FEMA flood zones, land cover, imperviousness, elevation, income, and population density. A selection of a FR factor type may show the one or more summary statistics (e.g., calculated by map data summarizer 204) via a heat map for the various sub-regions. In FIG. 3A, “none” is selected, thus map 300 only shows the boundaries between the common region-subdivision schema (e.g., watershed basins-based) that is used in the non-limiting embodiment.

FIG. 3B shows heat maps of the summary statistics for various flood risk factor types, according to various embodiments. More particularly, FIG. 3B includes a flood zone heat map 310, a land cover heat map 312, and a surface imperviousness heat map 314. FIG. 3C shows additional heat maps of the summary statistics for additional flood risk factor types, according to various embodiments. More particularly, FIG. 3C includes an elevation heat map 316, a land cover heat map 318, and a population density heat map 320. Note that the sub-regions of the various heats maps of FIGS. 3A-3C are based on a watershed-basin subdivision schema. Also, the corresponding flood risk factor type is shown selected in the control panel 302 for each of the heat maps 310-320.

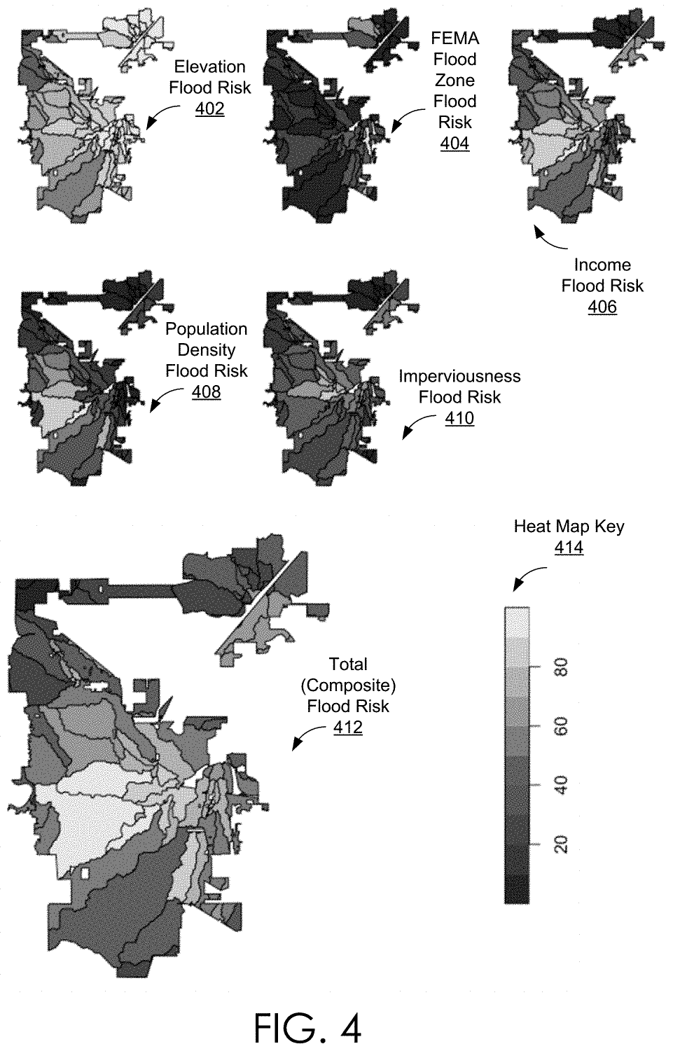

Turning our attention to FIG. 4, FIG. 4 shows heat maps for various composite and non-composite risk scores for the watershed basin-based subdivision schema that is consistent with various embodiments. More particularly, FIG. 4 shows the elevation flood risk heat map 402 for the FR factor (non-composite) elevation-based risk score that corresponds to the elevation-based flood risk factor. FIG. 4 also shows the FEMA flood zone flood risk heat map 404 for the FR factor (non-composite) flood zone-based risk score that corresponds to the FEMA flood zone FR factor type. FIG. 4 also shows the income flood risk heat map 406 for the FR factor (non-composite) income-based risk score that corresponds to the income FR factor type. FIG. 4 also shows the population density flood risk heat map 408 for the FR factor (non-composite) population density-based risk score that corresponds to the population density FR factor type. FIG. 4 also shows the imperviousness flood risk heat map 410 for the FR factor (non-composite) imperviousness-based risk score that corresponds to the imperviousness FR factor type. The non-composite risk scores for the various sub-regions may have been calculated by map data normalizer 208 of FIG. 2. FIG. 4 additionally shows the total (composite) flood risk heat map 412 for the total (composite) flood risk score. The total (composite) risk scores of heat map 412 may have been computed via one or more combinations of the non-composite risk scores of heat maps 402-410. The flood risk data integrator 210 of FIG. 2 may have computed the total (composite) risk scores for the sub-regions, based on a combination of the no-composite risk scores. FIG. 4 also provides a heat map key 414 that provides a map between colors and risk scores for the various heat maps.

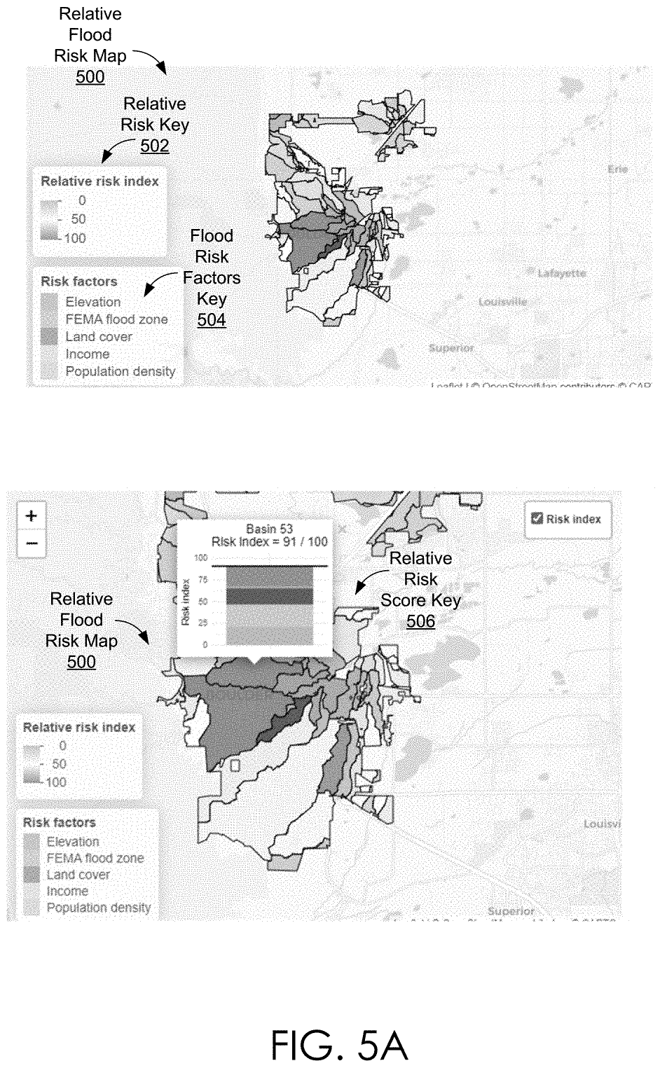

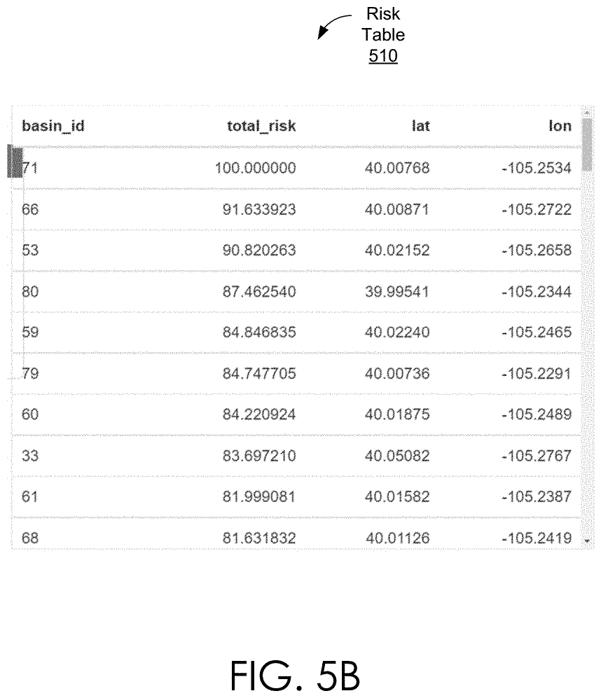

Turning our attention to FIG. 5A, FIG. 5A shows heat maps for relative (composite) risk scores for the watershed basin-based subdivision schema that is consistent with various embodiments. FIG. 5A shows the relative flood risk heat map 500 for the relative risk associated with the various sub-regions. Heat map 500 indicates the riskiest (with respect to flood risk) of the various sub-regions. Relative risk key 502 provides the key for heat map 500 with respect to the relative risk. Flood risk factors key 504 also provides the key for heat map 500 with respect to the various flood risk factors. As shown in the lower half of FIG. 5A, heat map 500 may be an interactive heat map. In the interactive version of heat map 500, each of the sub-regions is selectable (e.g., via a mouse click). When selected, a key for the selected sub-region may be provided via a pop-up 504. In the non-limiting embodiment of FIG. 5A, sub-region (e.g., flood basin) 53 has been selected. According to pop-up key 502, flood basin 53 has a relative risk score (with respect to the other sub-regions) of 91 out of 100.

Turning our attention to FIG. 5B, FIG. 5B provides a total (composite) risk table 510 for the watershed basin-based subdivision schema that is consistent with various embodiments. Risk table 510 provides a listing of the various sub-regions that are ranked by their total (composite) risk score. Risk table 510 additionally provides the total (composite) risk score for each of the sub-regions. In risk table 510, the sub-regions are ranked from riskiest to least risky. As shown in risk table 510, sub-region 53 is the third riskiest sub-region with a total risk score of 90.8. The latitude and longitude coordinates for each of the sub-regions are also shown in table 510.

### Example Methods for Modeling Flood Risk for a Region

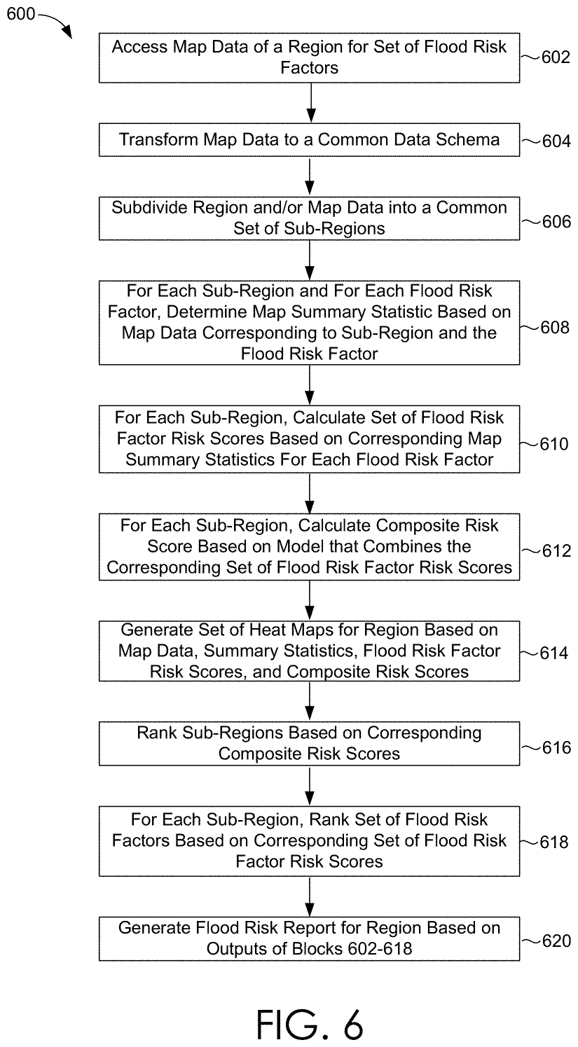

With reference to FIG. 6, a flow diagram is provided that illustrates a method for modeling the flood risk for a region. The method may be performed using any of the embodiments of a described herein. For example, a flood risk quantification (FRQ) platform (e.g., FRQ platform 120 of FIG. 1 and/or FRQ platform 200 of FIG. 2) may implement at least a portion of the method. In embodiments, one or more computer storage media having computer-executable instructions embodied thereon that, when executed, by one or more processors can cause the one or more processors to perform the methods in the storage system.

Turning to FIG. 6, a flow diagram is provided that illustrates a method 600 for modeling a flood risk for a region that is consistent with the various embodiments. Method 600 begins at block 602, where map data of a region is accessed and/or received. The map data may be for a set of flood risk factors. That is, the map data may include map data for a set of flood risk factors. The set of flood risk factors may include any of flood zone-based (e.g., FEMA flood zone) risk factor, a land cover-based risk factor, an imperviousness-based risk factor, an elevation-based risk factor, an income-based risk factor, and/or a population density-based risk factor. The map data may include a first set of map data (e.g., a first map dataset) corresponding to a flood zone-based risk factor of the set of flood risk factors. The map data may include a second set of map data corresponding to a land cover-based risk factor of the set of flood risk factors. The map data may include a third set of map data corresponding to an imperviousness-based risk factor of the set of flood risk factors. The map data may include a fourth set of map data corresponding to an elevation-based risk factor of the set of flood risk factors. The map data may include a fifth set of map data corresponding to an income-based risk factor of the set of flood risk factors. The map data may include a sixth set of map data corresponding to a population density-based risk factor of the set of flood risk factors. A map data transformer (e.g., map data transformer 202 of FRQ platform 200 of FIG. 2).

At block 604, each of the map datasets (e.g., a set of map data) included in the accessed/received map data is transformed to a common data schema. The map data transformer may transform the map data into a common data schema. At block 606, the map data transformer may transform the map data into a common region-subdivision schema. The region-subdivision schema may be based on the set of sub-regions. That is, the transformed map data is subdivided into a set of sub-regions of the region. In some embodiments, this may include subdividing the region and/or the map data into a common set of sub-regions. Once transformed, the set of sub-regions may be common to each map dataset in the map data (e.g., the set of sub-regions is a common set of sub-regions across the entirety of the map data). In at least one embodiment, an indication of the set of sub-regions may be received from a user. The region may be subdivided into the set of sub-regions. The map data may be subdivided based on the set of sub-regions. In some embodiments, the set of sub-regions may be based on zip codes, census tracts, watershed basins, evenly spaced grids, individual property parcels, or any other such mechanism.

At block 608, for each sub-region and for each flood risk factor, one or more summary statistics may be determined. A map data summarizer (e.g., map data summarizer 204 of FRQ platform 200) may determine the summary statistics. The determination of the summary statistics may be based on a portion of the map data corresponding to the flood risk factor and the sub-region. The summary statistics may be stored in a 2D or a 3D data array (e.g., summarized map data). The summarized map data may be stored in a summarized map data database (e.g., summarized map data DB 206 of FRQ platform 200)

At block 610, for each sub-region, a set of flood risk factor scores may be calculated, generated, and/or determined. Calculating the set of flood risk scores for a sub-region may be based on the transformed map data. More specifically, calculating the set of flood risk scores for a sub-region may be based on the corresponding map summary statistics (for the sub-region) and for each floor risk factor. Each flood risk factor risk score may correspond to one of the flood risk factors of the set of flood risk factors. A map data normalizer (e.g., map data normalizer 208 of FRQ platform 200) may calculate the set of flood risk factor risk scores for each sub-region.

At block 612, for each sub-region, a composite risk score is calculated, generated, and/or determined. Calculating the composite risk score may be based on a model that combines the corresponding set of flood risk factor risk scores for the sub-region. A flood risk data integrator (e.g., FR data integrator 210 of FRQ platform 200) may calculate the composite risk scores.

A block 614, a set of heat maps for the region may be generated based on the map data, the summary statistics, the sets of flood risk factor risk scores, and the composite risk scores for the sub-regions. The heat maps may be interactive heat maps. Various embodiments of such heat maps are discussed in conjunction with at least FIGS. 3A-5B. At block 616, the sub-regions of the set of sub-regions may be ranked based on the corresponding composite risk scores. At block 618, for each sub-region, the set of flood risk factors is ranked based on the sub-region's corresponding set of flood risk factor risk scores.

At block 620, a flood risk report (e.g., flood risk report 226 of FIG. 2) may be generated based on the outputs and/or actions of blocks 602-618. More specifically, the flood risk report may be based on the set of flood risk factor risk scores and the composite flood risk score corresponding to each of the sub-regions of the set of sub-regions. The flood risk report may be an interactive heat map. The flood risk report may include a list (or table) that includes a ranking of set of sub-regions based on the composite flood risk score for the corresponding sub-region. The flood risk report may include a list (or table) that includes a ranking of set of sub-regions based on the composite flood risk score for the corresponding sub-region. The flood risk report may include an interactive heat map of the region that indicates one or more summary statistics corresponding to each flood risk factor of the set of flood risk factors. The flood risk report may include an interactive heat map of the region that indicates each flood risk factor score of the set of flood risk factors. A floor risk report generator (e.g., FR report generator 212 of FRQ platform 200) may generate the flood risk report.

### Other Embodiments

The embodiments may be directed towards one or more of methods, system, and/or non-transitory computer readable storage media. In one exemplary, but non-limiting method embodiment, the method may include receiving and/or accessing map data for a region. The accessed map data includes map data for a set of flood risk factors. The map data may be transformed to a common data schema. The transformed map data is subdivided into a set of sub-regions of the region. For each sub-region of the set of sub-regions, a set of flood risk factor scores is determined based on the transformed map data. The set of flood risk factor scores corresponds to the set of flood risk factors. For each sub-region of the set of sub-regions, a composite flood risk score is determined. Determining the composite flood risk score for the sub-region may be based on a combination of flood risk factor scores included in the set flood risk factor scores corresponding to the sub-region. A flood risk report may be generated for the region. The flood risk report may be based on the set of flood risk factor scores and the composite flood risk score corresponding to each of the sub-regions of the set of sub-regions.

In at least one embodiment, the method may include transforming the map data to a common region-subdivision schema. The common region-subdivision may be based on the set of sub-regions, such that the set of sub-regions is a common set of sub-regions across an entirety of the map data. In another embodiment, the method may include receiving an indication of the set of sub-regions. The region may be subdivided into the set of sub-regions. The map data may be subdivided based on the set of sub-regions.

In some embodiments, the method may further include, for each flood risk factor of the set of flood risk factors and for each sub-region of the set of sub-regions, determining one or more summary statistics. Determining the summary statistics may be based on a portion of the map data corresponding to the flood risk factor and the sub-region. For each sub-region of the set of sub-regions, the set of flood risk factor scores may be determined based on the one or more summary statistics corresponding to the sub-region and each flood risk factor.

In some embodiments, the map data may include a first set of map data corresponding to a flood zone-based risk factor of the set of flood risk factors. The map data may include a second set of map data corresponding to a land cover-based risk factor of the set of flood risk factors. The map data may include a third set of map data corresponding to an imperviousness-based risk factor of the set of flood risk factors. The map data may include a fourth set of map data corresponding to an elevation-based risk factor of the set of flood risk factors. The map data may include a fifth set of map data corresponding to an income-based risk factor of the set of flood risk factors. The map data may include a sixth set of map data corresponding to a population density-based risk factor of the set of flood risk factors.

In some embodiments, the flood risk report may include a list that includes a ranking of set of sub-regions based on the composite flood risk score for the corresponding sub-region. The flood risk report may include a list, for each sub-region of the set of sub-regions, that includes a ranking of the set of flood risk factors based on the set of flood risk factor scores corresponding to the sub-region. In at least one embodiment, the flood risk report may include an interactive heat map of the region that indicates one or more summary statistics corresponding to each flood risk factor of the set of flood risk factors. The flood risk report may include an interactive heat map of the region that indicates each flood risk factor score of the set of flood risk factors.

### Generalized Computing Device

With reference to FIG. 7, computing device 700 includes a bus 710 that directly or indirectly couples the following devices: memory 712, one or more processors 714, one or more presentation components 716, one or more input/output (I/O) ports 718, one or more I/O components 720, and an illustrative power supply 722. Bus 710 represents what may be one or more busses (such as an address bus, data bus, or combination thereof). Although the various blocks of FIG. 7 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 7 and with reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors 714 that read data from various entities such as memory 712 or I/O components 720. Presentation component(s) 716 presents data indications to a user or other device. Other examples of presentation components may include a display device, speaker, printing component, vibrating component, and the like.

The I/O ports 718 allow computing device 700 to be logically coupled to other devices, including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

Some embodiments of computing device 700 may include one or more radio(s) 724 (or similar wireless communication components). The radio 724 transmits and receives radio or wireless communications. The computing device 700 may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present disclosure.

By way of example, the technical solution system can include an Application Programming Interface (API) library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present disclosure are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code.

Further, while embodiments of the present disclosure may generally refer to the technical solution environment and the schematics described herein, it is understood that the techniques described may be extended to other implementation contexts.

Embodiments of the present disclosure have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computer-implemented method comprising:
accessing map data for a region, wherein the accessed map data includes map data for a set of flood risk factors;
transforming the map data to a common data schema, wherein the transformed map data is subdivided into a set of sub-regions of the region;
for each sub-region of the set of sub-regions, determining a set of flood risk factor scores based on the transformed map data, wherein the set of flood risk factor scores corresponds to the set of flood risk factors;
for each sub-region of the set of sub-regions, determining a composite flood risk score based on a combination of flood risk factor scores included in the set flood risk factor scores corresponding to the sub-region; and
generating a flood risk report for the region based on the set of flood risk factor scores and the composite flood risk score corresponding to each of the sub-regions of the set of sub-regions.

2. The method of claim 1, wherein transforming the map data includes:
transforming the map data to a common region-subdivision schema that is based on the set of sub-regions, such that the set of sub-regions is a common set of sub-regions across an entirety of the map data.

3. The method of claim 1, further comprising:
receiving an indication of the set of sub-regions;
subdividing the region into the set of sub-regions; and
subdividing the map data based on the set of sub-regions.

4. The method of claim 1, further comprising;
for each flood risk factor of the set of flood risk factors and for each sub-region of the set of sub-regions, determining one or more summary statistics based on a portion of the map data corresponding to the flood risk factor and the sub-region; and
for each sub-region of the set of sub-regions, determining the set of flood risk factor scores based on the one or more summary statistics corresponding to the sub-region and each flood risk factor.

5. The method of claim 1, wherein the map data includes at least one of:
a first set of map data corresponding to a flood zone-based risk factor of the set of flood risk factors;
a second set of map data corresponding to a land cover-based risk factor of the set of flood risk factors;
a third set of map data corresponding to an imperviousness-based risk factor of the set of flood risk factors;
a fourth set of map data corresponding to an elevation-based risk factor of the set of flood risk factors;
a fifth set of map data corresponding to an income-based risk factor of the set of flood risk factors; and
a sixth set of map data corresponding to a population density-based risk factor of the set of flood risk factors.

6. The method of claim 1, wherein the flood risk report for the region includes at least one of:
a list that includes a ranking of set of sub-regions based on the composite flood risk score for the corresponding sub-region; and
a list, for each sub-region of the set of sub-regions, that includes a ranking of the set of flood risk factors based on the set of flood risk factor scores corresponding to the sub-region.

7. The method of claim 1, wherein the flood risk report for the region includes at least one of:
an interactive heat map of the region that indicates one or more summary statistics corresponding to each flood risk factor of the set of flood risk factors; and
an interactive heat map of the region that indicates each flood risk factor score of the set of flood risk factors.

8. A system comprising:
one or more hardware processors; and
one or more computer-readable media having executable instructions embodied thereon, which, when executed by the one or more processors, cause the one or more hardware processors to execute actions method comprising:
accessing map data for a region, wherein the accessed map data includes map data for a set of flood risk factors;
transforming the map data to a common data schema, wherein the transformed map data is subdivided into a set of sub-regions of the region;
for each sub-region of the set of sub-regions, determining a set of flood risk factor scores based on the transformed map data, wherein the set of flood risk factor scores corresponds to the set of flood risk factors;
for each sub-region of the set of sub-regions, determining a composite flood risk score based on a combination of flood risk factor scores included in the set flood risk factor scores corresponding to the sub-region; and
generating a flood risk report for the region based on the set of flood risk factor scores and the composite flood risk score corresponding to each of the sub-regions of the set of sub-regions.

9. The system of claim 8, wherein the actions further comprise:
transforming the map data to a common region-subdivision schema that is based on the set of sub-regions, such that the set of sub-regions is a common set of sub-regions across an entirety of the map data.

10. The system of claim 8, wherein the actions further comprise:
receiving an indication of the set of sub-regions;
subdividing the region into the set of sub-regions; and
subdividing the map data based on the set of sub-regions.

11. The system of claim 8, wherein the actions further comprise:
for each flood risk factor of the set of flood risk factors and for each sub-region of the set of sub-regions, determining one or more summary statistics based on a portion of the map data corresponding to the flood risk factor and the sub-region; and
for each sub-region of the set of sub-regions, determining the set of flood risk factor scores based on the one or more summary statistics corresponding to the sub-region and each flood risk factor.

12. The system of claim 8, wherein the actions further comprise:
a first set of map data corresponding to a flood zone-based risk factor of the set of flood risk factors;
a second set of map data corresponding to a land cover-based risk factor of the set of flood risk factors;
a third set of map data corresponding to an imperviousness-based risk factor of the set of flood risk factors;
a fourth set of map data corresponding to an elevation-based risk factor of the set of flood risk factors;
a fifth set of map data corresponding to an income-based risk factor of the set of flood risk factors; and
a sixth set of map data corresponding to a population density-based risk factor of the set of flood risk factors

13. The system of claim 8, wherein the flood risk report for the region includes at least one of:
a list that includes a ranking of set of sub-regions based on the composite flood risk score for the corresponding sub-region; and
a list, for each sub-region of the set of sub-regions, that includes a ranking of the set of flood risk factors based on the set of flood risk factor scores corresponding to the sub-region.

14. The system of claim 8, wherein the flood risk report for the region includes at least one of:
an interactive heat map of the region that indicates one or more summary statistics corresponding to each flood risk factor of the set of flood risk factors; and
an interactive heat map of the region that indicates each flood risk factor score of the set of flood risk factors.

15. One or more computer storage media storing computer-useable instructions that, when used by one or more computing devices, cause the one or more computing devices to perform actions comprising:
accessing map data for a region, wherein the accessed map data includes map data for a set of flood risk factors;
transforming the map data to a common data schema, wherein the transformed map data is subdivided into a set of sub-regions of the region;
for each sub-region of the set of sub-regions, determining a set of flood risk factor scores based on the transformed map data, wherein the set of flood risk factor scores corresponds to the set of flood risk factors;
for each sub-region of the set of sub-regions, determining a composite flood risk score based on a combination of flood risk factor scores included in the set flood risk factor scores corresponding to the sub-region; and
generating a flood risk report for the region based on the set of flood risk factor scores and the composite flood risk score corresponding to each of the sub-regions of the set of sub-regions.

16. The media of claim 15, wherein transforming the map data includes:
transforming the map data to a common region-subdivision schema that is based on the set of sub-regions, such that the set of sub-regions is a common set of sub-regions across an entirety of the map data.

17. The media of claim 15, wherein the actions further comprise:
receiving an indication of the set of sub-regions;
subdividing the region into the set of sub-regions; and
subdividing the map data based on the set of sub-regions.

18. The media of claim 15, wherein the actions further comprise:
for each flood risk factor of the set of flood risk factors and for each sub-region of the set of sub-regions, determining one or more summary statistics based on a portion of the map data corresponding to the flood risk factor and the sub-region; and
for each sub-region of the set of sub-regions, determining the set of flood risk factor scores based on the one or more summary statistics corresponding to the sub-region and each flood risk factor.

19. The media of claim 15, wherein the map data includes at least one of:
a first set of map data corresponding to a flood zone-based risk factor of the set of flood risk factors;
a second set of map data corresponding to a land cover-based risk factor of the set of flood risk factors;
a third set of map data corresponding to an imperviousness-based risk factor of the set of flood risk factors;
a fourth set of map data corresponding to an elevation-based risk factor of the set of flood risk factors;
a fifth set of map data corresponding to an income-based risk factor of the set of flood risk factors; and
a sixth set of map data corresponding to a population density-based risk factor of the set of flood risk factors.

20. The media of claim 15, wherein the flood risk report for the region includes at least one of:
a list that includes a ranking of set of sub-regions based on the composite flood risk score for the corresponding sub-region;
a list, for each sub-region of the set of sub-regions, that includes a ranking of the set of flood risk factors based on the set of flood risk factor scores corresponding to the sub-region;
an interactive heat map of the region that indicates one or more summary statistics corresponding to each flood risk factor of the set of flood risk factors; and
an interactive heat map of the region that indicates each flood risk factor score of the set of flood risk factors.
